(19) United States
(12) Patent Application Publication
(10) Pub. No.: US 2025/0298299 A1
(43) Pub. Date: Sep. 25, 2025

(54) OPTICAL DEVICE AND IMAGING FORMING APPARATUS

(71) Applicant: TDK CORPORATION, Tokyo (JP)

(72) Inventors: Hiroshi Take, Hong Kong (HK); Kenji Nagase, Hong Kong (HK); Cheng Bu Heng, Hong Kong (HK); Anthony Reymund Melad Binarao, Hong Kong (HK)

(73) Assignee: TDK CORPORATION, Tokyo (JP)

(21) Appl. No.: 19/079,674

(22) Filed: Mar. 14, 2025

(30) Foreign Application Priority Data
Mar. 21, 2024 (JP) 2024-044970

(51) Int. Cl. G03B 21/20; G02F 1/035; G03B 21/28

(52) U.S. Cl. CPC G03B 21/2033; G02F 1/035; G03B 21/2013; G03B 21/28; G02F 2201/066; G02F 2202/20

(57) ABSTRACT

The optical device includes: a substrate; a waveguide layer which is formed on the substrate and which has an optical waveguide for propagating light; a protective layer provided on the waveguide layer; and a groove which extends from the protective layer to the waveguide layer, wherein the groove includes a first side surface and a second side surface which opposes the first side surface, the first side surface and the second side surface expose end surfaces of the waveguide layer and the protective layer, and the second side surface has a rough surface.

### CROSS REFERENCE TO RELATED APPLICATION

This application claims the benefit of Japanese Priority Patent Application No. 2024-044970 filed on Mar. 21, 2024, the entire contents of which are incorporated herein by reference.

### FIELD

The present disclosure relates to an optical device and an image forming apparatus.

### BACKGROUND

Optical devices with optical waveguides are used by connecting the optical devices to laser diodes that serve as light sources, optical fibers that propagate communication signals, other optical devices, and the like. In such an optical device, stray light leaking from a waveguide layer can hinder the optical device from performing its intended function. In consideration thereof, in order to block stray light leaking from the waveguide layer, measures such as providing wall-shaped or columnar wiring electrodes in optical devices are being put into practical use (for example, refer to Patent Publication JP-A-2020-205373).

### SUMMARY

However, given that embedding wiring electrodes in optical devices in order to block stray light is a complicated and costly process, a simpler and more effective stray light countermeasure has been sought.

An optical device according to a first aspect of the present disclosure includes: a substrate; a waveguide layer which is formed on the substrate and which has an optical waveguide for propagating light; a protective layer provided on the waveguide layer; and a groove which extends from the protective layer to the waveguide layer, wherein the groove includes a first side surface and a second side surface which opposes the first side surface, the first side surface and the second side surface expose end surfaces of the waveguide layer and the protective layer, and the second side surface has a rough surface.

In addition, an image forming apparatus according to a second aspect of the present disclosure adopts the optical device described above.

The present disclosure enables an optical device and the like capable of readily and effectively attenuating stray light from a waveguide layer to be provided.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a schematic view describing a configuration of a projector which adopts a light source unit including an optical device according to one example embodiment;

FIGS. 2A and 2B are a plan view and a front view of the light source unit;

FIG. 3 is a sectional view taken along X-X of a groove as a first example;

FIG. 4 is a sectional view taken along X-X of a groove as a second example; and

FIG. 5 is a partial perspective view of a groove as a third example.

### DETAILED DESCRIPTION

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions.

An example embodiment of the present disclosure will be described with reference to the accompanying drawings. Note that elements designated by same reference signs in the respective drawings share an identical or a similar configuration. In addition, when structures sharing an identical or a similar configuration exist in plurality in each drawing, some structures may be accompanied with signs while others may not in order to avoid complication. Note that the disclosure related to the scope of aspects is not limited to the example embodiment described below. In addition, not all of the components described in the example embodiment are essential as means for solving the problem.

The present disclosure has been made to solve such problems, and an object thereof is to provide an optical device and the like capable of readily and effectively attenuating stray light from a waveguide layer.

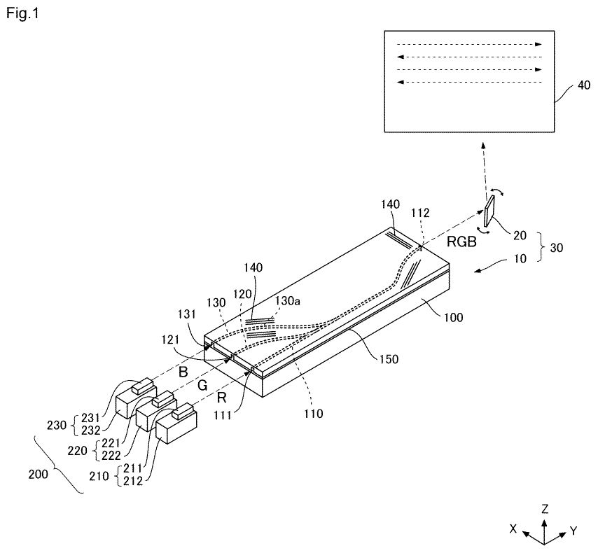

FIG. 1 is a schematic view describing a configuration of a projector 30 which adopts a light source unit 10 including an optical device 100 according to the present example embodiment. The projector 30 reflects projected light emitted from the light source unit 10 by using a MEMS (Micro Electro Mechanical Systems) mirror to change direction over time and scans a screen 40 with the projected light, thereby projecting images onto the screen 40. The projector 30 is an aspect of the image forming apparatus.

The light source unit 10 may be made up of the optical device 100 and a light-emitting device 200. The light-emitting device 200 is made up of three light-emitting modules: a red light-emitting module 210, a green light-emitting module 220, and a blue light-emitting module 230. While the light-emitting modules are integrated by being joined to an end surface of the optical device 100 as will be described later, in the drawing, each light-emitting module is drawn separated from the end surface of the optical device 100.

The optical device 100 may have a shape of a rectangular parallelepiped as a whole and, in the drawing, a lateral direction among planar directions is defined as an X-axis direction, a longitudinal direction among the planar directions is defined as a Y-axis direction, and a height direction orthogonal to the planar directions is defined as a Z-axis direction. Note that in subsequent drawings, similar coordinate axes with respect to the state in which the optical device 100 is arranged as shown in FIG. 1 are shown together to indicate an orientation of a structure represented by each drawing.

The optical device 100 has a waveguide layer 150 parallel to the XY plane. The waveguide layer 150 is formed of an electro-optical material such as a lithium niobate film, and partial removal of a portion of the electro-optical material by etching or the like leaves a ridge portion that is convex in a cross-section. The ridge portion functions as an optical waveguide through which light passes, and in the present example embodiment, three optical waveguides are formed on the waveguide layer: a first optical waveguide 110, a second optical waveguide 120, and a third optical waveguide 130. Specifically, the optical waveguides may include three input waveguides and an output waveguide where the three input waveguides merge.

The first optical waveguide 110 may be continuous by a straight line or a gentle curve from a first incidence end surface 111 which is exposed on one side surface of the optical device 100 to an exit end surface 112 which is exposed on one side surface on an opposite side of the optical device 100. In other words, light incident on the first incidence end surface 111 proceeds along the first optical waveguide 110 and exits from the exit end surface 112.

The second optical waveguide 120 may be continuous by a straight line or a gentle curve from a second incidence end surface 121 which is exposed on the one side surface of the optical device 100 provided with the first incidence end surface 111 until merging with a middle portion of the first optical waveguide 110. In other words, light incident on the second incidence end surface 121 proceeds along the second optical waveguide 120, merges with the first optical waveguide 110 along the way, and exits from the exit end surface 112.

The third optical waveguide 130 may be continuous by a straight line or a gentle curve from a third incidence end surface 131 which is exposed on the one side surface of the optical device 100 provided with the first incidence end surface 111 until merging with a middle portion of the first optical waveguide 110. In other words, light incident on the third incidence end surface 131 proceeds along the third optical waveguide 130, merges with the first optical waveguide 110 along the way, and exits from the exit end surface 112.

Note that a configuration of the three optical waveguides is not limited to the example described above and need only be a configuration in which each optical waveguide has an incidence end surface, and the optical waveguides merge along the way and share a common exit end surface. Alternatively, a configuration may be adopted with two or more exit end surfaces due to branching downstream from where the three optical waveguides merge.

The red light-emitting module 210 may be made up of a red laser diode 211 and a first carrier 212 that supports the red laser diode 211. The red laser diode 211 is fixed to the first carrier 212. Red laser light emitted from the red laser diode 211 is incident on the first incidence end surface 111 of the first optical waveguide 110.

The green light-emitting module 220 may be made up of a green laser diode 221 and a second carrier 222 that supports the green laser diode 221. The green laser diode 221 is fixed to the second carrier 222. Green laser light emitted from the green laser diode 221 is incident on the second incidence end surface 121 of the second optical waveguide 120.

The blue light-emitting module 230 may be made up of a blue laser diode 231 and a third carrier 232 that supports the blue laser diode 231. The blue laser diode 231 is fixed to the third carrier 232. Blue laser light emitted from the blue laser diode 231 is incident on the third incidence end surface 131 of the third optical waveguide 130.

As described above, since the second optical waveguide 120 and the third optical waveguide 130 merge with the first optical waveguide 110, when a plurality of laser diodes simultaneously emit light, a mixed light of the laser diodes is emitted from the exit end surface 112. More specifically, when causing the red laser diode 211, the green laser diode 221, and the blue laser diode 231 to emit light while controlling emission intensity of each laser diode, light of any target color can be emitted from the exit end surface 112.

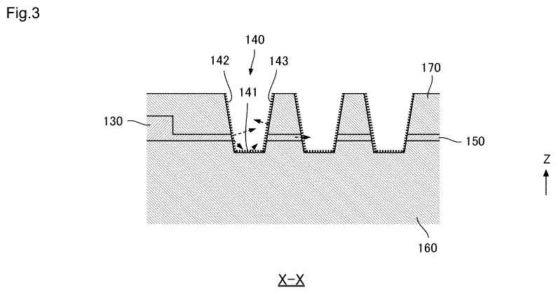

The optical device 100 includes a groove 140 from a protective layer 170 to the waveguide layer 150 (refer to FIG. 3). The groove 140 includes a first side surface 142 and a second side surface 143 which opposes the first side surface 142, and the first side surface 142 and the second side surface 143 expose end surfaces of the waveguide layer 150 and the protective layer 170 (refer to FIG. 3). In addition, the second side surface 143 has a rough surface.

The groove 140 for blocking stray light propagating through the waveguide layer 150 may be provided at a location that does not divide each optical waveguide. The groove 140 may be provided along a curved portion of an optical waveguide (for example, a curved portion 130a of the third optical waveguide 130) as illustrated or provided in a vicinity of the exit end surface 112. In other words, the groove 140 may be provided near locations on the path of the optical waveguides where stray light is assumed to be likely to occur or near locations where an effect of stray light on exit light is assumed to be significant. The groove 140 is provided at one or more locations depending on the configuration of the optical waveguides, performance required of the optical device 100, or the like.

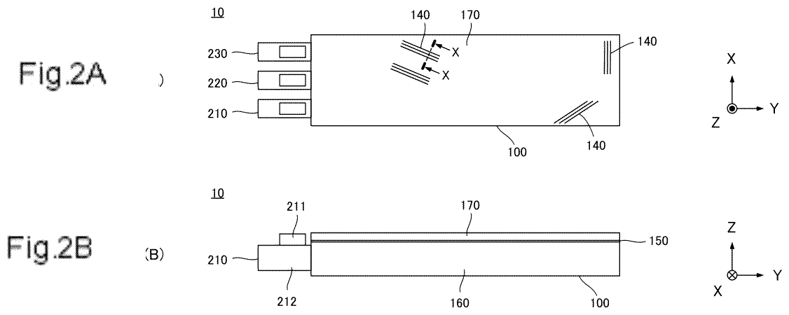

FIGS. 2A and 2B are a plan view (FIG. 2A) and a front view (FIG. 2B) of the light source unit 10. As shown in the front view, the optical device 100 includes a substrate 160, the waveguide layer 150 stacked on the substrate 160, and the protective layer 170 which covers the waveguide layer. For example, a Si substrate or a sapphire substrate is used as the substrate 160. For example, silicon dioxide (SiO₂) is used as the protective layer 170. For example, the protective layer 170 may be configured as a buffer layer which adopts a material such as alumina (Al₂O₃). Alternatively, the protective layer 170 may be configured as a cladding layer which adopts a material such as yttrium oxide (Y₂O₃). As shown in the plan view, in the present example embodiment, the groove 140 is provided at a plurality of locations on a side of the protective layer 170. While each groove 140 has a straight shape in the present example embodiment, for example, the groove 140 may have a curved shape along a path of the optical waveguides or a bent shape such as an L-shape.

The carrier (first carrier 212, second carrier 222, or third carrier 232) of each light-emitting module (red light-emitting module 210, green light-emitting module 220, or blue light-emitting module 230) is bonded to the substrate 160 and integrated with the optical device 100. Note that one side surface of the optical device 100 to which each light-emitting module is joined may have an anti-reflective coat and an SAC coat and one side surface on an opposite side where the exit end surface 112 is provided may have an anti-reflective coat. In addition, a joint surface of each carrier with the substrate 160 may have an Au coat.

FIG. 3 is a sectional view taken along X-X of the groove 140 as a first example in the present example embodiment. As illustrated, the groove 140 may include two side surfaces (the first side surface 142 and the second side surface 143) and may further include a bottom surface 141 that connects the first side surface 142 to the second side surface 143. For example, the groove 140 may have an approximate U-shape in its cross section which is opened in the +Z axis direction. The first side surface 142 is a side surface on a side provided with an optical waveguide (the third optical waveguide 130 in the illustrated example) and the second side surface is a side surface on a side not provided with an optical waveguide.

Since the groove 140 is provided to attenuate stray light propagating through the waveguide layer 150, the groove 140 has a depth that penetrates the protective layer 170 and the waveguide layer 150 to reach the substrate 160. In particular, in the present example embodiment, surfaces (bottom surface 141, first side surface 142, and second side surface 143) of the groove 140 are roughened to ensure that stray light leaking from the waveguide layer 150 into a space in the groove 140 is moderately scattered by the surfaces of the groove 140. Note that the groove 140 need not be drilled down to the substrate 160 and need only be deep enough to, for example, divide the protective layer 170 and the waveguide layer 150 so that a plane of the substrate 160 is exposed as the bottom surface 141.

Roughening of the surfaces of the groove 140 is realized by, for example, irradiating the surfaces with argon (Ar) gas or xenon (Xe) gas using a milling apparatus after groove formation. Considering the wavelength of light incident on the optical waveguides, an arithmetic mean roughness (Ra) of the surface of the groove 140 may be 5 nm or more and less than 15 nm. In particular, the arithmetic mean roughness (Ra) of the rough surface included in the second side surface 143 may be 5 nm or more and less than 15 nm. It was confirmed through an experiment that, in order to achieve such an Ra, for example, a beam voltage need only be adjusted in a range of 250 V to 450 V when using argon gas in the milling apparatus described above.

According to the groove 140 structured as described above, stray light leaking from the waveguide layer 150 into the space in the groove 140 reaches the bottom surface 141, the first side surface 142, and the second side surface 143 where it is scattered well, and the stray light is further attenuated by repeated scattering. Alternatively, the stray light is released into an upper release space. Therefore, it is expected that stray light will be prevented from returning to the optical waveguide as returned light or prevented from propagating through the waveguide layer 150 and reaching the exit end surface 112. In particular, in an application of mixing laser light of respective colors in optical waveguides and emitting light with an optional target color as in the present example embodiment, it is expected that stray light will be prevented from compromising color balance.

To further enhance this effect, the Ra of the two side surfaces (first side surface 142 and second side surface 143) which intersect with the waveguide layer 150 may be larger than the Ra of the bottom surface 141 which is parallel to the waveguide layer 150. In particular, the arithmetic mean roughness (Ra) of the second side surface 143 may be larger than the arithmetic mean roughness (Ra) of the bottom surface 141. By adopting such a configuration, it is expected that a larger amount of stray light will be scattered by the side surfaces and released to the release space. In addition, in order to release a larger amount of stray light to the release space, each surface may be in contact with air without having the space in the groove 140 filled with another medium. In other words, each surface may be exposed to air.

In addition, as illustrated, by providing a plurality of grooves 140 (three in the illustrated example) in succession, even if a part of stray light enters the waveguide layer 150 beyond the grooves 140, it is expected that the stray light will scatter again within the space of the successive grooves 140, thereby significantly reducing stray light. Note that the successive grooves 140 may all have the same configuration or mutually different configurations.

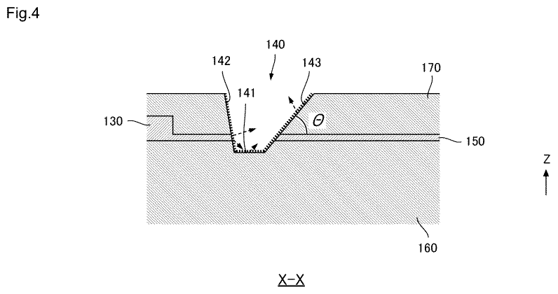

FIG. 4 is a sectional view taken along X-X of the groove 140 as a second example in the present example embodiment. The surface of the groove 140 as the second example is also roughened. The groove 140 as the second example has different inclination angles for the first side surface 142 and the second side surface 143. More specifically, an angle (denoted by θ in the drawing) that the second side surface 143 forms with respect to a planar direction of the waveguide layer 150 is made smaller than an angle that the first side surface 142 forms with respect to the planar direction of the waveguide layer 150. Adopting such a configuration causes a large portion of stray light that propagates through the waveguide layer 150 from the optical waveguides and leaks out into the space in the groove 140 to reach the second side surface 143 and scatter to be guided to the release space. In other words, it is expected that stray light will be diffused more efficiently. θ in this case may be adjusted to be 30° or more and less than 60°. Note that while the second side surface 143 is further inclined in the example shown in FIG. 4, an angle formed by the first side surface 142 with respect to the planar direction of the waveguide layer 150 may also be adjusted to be 30° or more and less than 60°.

In addition, from such a perspective, the first side surface 142 may be positioned closer to an optical waveguide than the second side surface 143. For example, when the groove 140 is formed along an optical waveguide, the first side surface 142 may be positioned on a side of the optical waveguide.

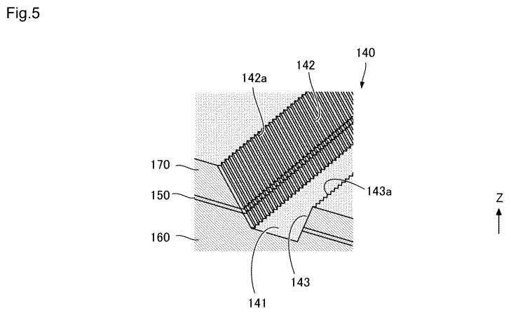

FIG. 5 is a partial perspective view of the groove 140 as a third example in the present example embodiment. The surface of the groove 140 as the third example is also roughened. The groove 140 as the third example may have a ridge 142a and a ridge 143a which extend in a depth direction on the first side surface 142 and the second side surface 143. In FIG. 5, pluralities of the ridges 142a and 143a are provided lined up along the surfaces of the first side surface 142 and the second side surface 143. With the groove 140 having such a structure, since more stray light leaking from the waveguide layer 150 into the space in the groove 140 will be reflected and scattered in a direction parallel to the planar direction of the waveguide layer 150, it is expected that the stray light will be repeatedly reflected and scattered at the ridges 142a and 143a and attenuated in stages.

While the groove 140 in the present example embodiment described above has an approximately U-shaped cross-sectional configuration with the bottom surface 141 and two side surfaces (first side surface 142 and second side surface 143) in all of the examples, alternatively, the groove 140 may have an approximately V-shaped cross-sectional configuration without the bottom surface 141. Since adopting the V-shaped configuration enables a width of one groove to be narrowed, the number of grooves 140 which can be formed at one location can be increased.

In addition, while the optical device 100 which emits light of an optional target color by mixing primary color laser light of RGB in an optical waveguide has been described in the present example embodiment described above, applications of the optical device are not limited to such so-called RGB couplers. An optical device to be used in another application may have one light-emitting module, in which case the optical waveguide need only be formed by a single path. In a similar manner, even when a plurality of light-emitting modules are to be joined, the number of light-emitting modules is not limited to three and may be two or four or more. In such a case, a plurality of incidence end surfaces corresponding to the number of light-emitting modules may be formed together with optical waveguides and may merge into a single waveguide or the optical waveguides may have exit end surfaces that are independent of each other.

1. An optical device, comprising:
a substrate;
a waveguide layer which is formed on the substrate and which has an optical waveguide for propagating light;
a protective layer provided on the waveguide layer; and
a groove which extends from the protective layer to the waveguide layer, wherein
the groove includes a first side surface and a second side surface which opposes the first side surface,
the first side surface and the second side surface expose end surfaces of the waveguide layer and the protective layer, and
the second side surface has a rough surface.

2. The optical device according to claim 1, wherein
the optical waveguide has a curved portion, and
the groove is provided along the curved portion.

3. The optical device according to claim 1, wherein
at least one of the first side surface and the second side surface forms an angle of 30° or more and less than 60° with respect to a planar direction of the waveguide layer.

4. The optical device according to claim 1, wherein
the first side surface is closer to the optical waveguide than the second side surface.

5. The optical device according to claim 1, wherein
the groove further has a bottom surface which connects the first side surface to the second side surface, and
an arithmetic mean roughness (Ra) of the second side surface is larger than an arithmetic mean roughness (Ra) of the bottom surface.

6. The optical device according to claim 1, wherein
an arithmetic mean roughness (Ra) of the rough surface is 5 nm or more and less than 15 nm.

7. The optical device according to claim 1, wherein
the first side surface and the second side surface have ridges extending in a depth direction of the groove.

8. The optical device according to claim 1, wherein
the first side surface and the second side surface are exposed to air.

9. The optical device according to claim 1, wherein
the optical waveguide has three input waveguides and an output waveguide where the three input waveguides merge.

10. An image forming apparatus adopting the optical device according to claim 9.
